(19) United States
(12) Patent Application Publication
(10) Pub. No.: US 2008/0120159 A1
(43) Pub. Date: May 22, 2008

(54) Enterprise resource planning system enhancement for program management

(75) Inventors: Kenneth P. Cidela, Glastonbury, CT (US); Thomas J. Fanciullo, Hebron, CT (US); Joseph Hanley, Belmont, MA (US)

Correspondence Address: CARLSON, GASKEY & OLDS/PRATT & WHITNEY, 400 WEST MAPLE ROAD, SUITE 350, BIRMINGHAM, MI, 48009, US

(73) Assignee: United Technologies Corporation

(21) Appl. No.: 11/601,481

(22) Filed: Nov. 17, 2006

(51) Int. Cl. G06Q 10/00

(52) U.S. Cl. 705/8; 707/102; 715/764; 707/E17.005

(57) ABSTRACT

A method for automating the management of an enterprise resource planning system comprises defining a first resource plan and storing the first resource plan into a first table, automatically storing the first resource plan into a resource plan space, and performing a first resource plan command and revising the first resource plan to define a revised first resource plan in response to a requested change. A second resource plan is defined and stored within a second table. In response to a requested change, a second resource plan command is performed and the second resource plan is revised within the working space to define a revised second resource plan and subsequently stored within the second table. In one example, the second resource plan is automatically revised in response to the revisions reflected in the first resource plan.

### BACKGROUND OF THE INVENTION

The present invention generally relates to organizational management systems, and more particularly to a method of automating the management of an enterprise resource planning system.

With the advent of computers, organizational management of a business's activities has become increasingly more automated. Organizational management systems, such as enterprise resource planning systems, which integrate and automate various aspects of a company's business including sales, delivery and production are known. Enterprise resource planning systems provide users with the ability to integrate various company operations into a single system and provide a real time business application that can be used with multiple currencies and languages.

One known enterprise resource planning system is provided under the trade name SAP (Systems, Applications and Products in Data Processing), which is commercially available from SAP AG in Germany. The SAP software package comprises a wide variety of business modules which include subprograms and data structures for the management of the various aspects of a business organization.

The SAP software package is particularly useful in performing effective program management. For example, the SAP software package may be used to manage the labor, material and scheduling requirements involved in developing a new product line. Often, a customer may require resource plan schedules, including a baseline plan and an estimate at complete (EAC) plan, to be maintained independently and simultaneously throughout the development of the new product line for costing and reporting purposes. The baseline plan (i.e. original plan as defined at time=0) predicts the costs involved in completing the development of the new product line. This includes predictions for the total amount of labor, material, overhead and scheduling. The EAC plan (i.e. operating plan) projects the total costs of a project at completion (i.e. time=n hours).

The SAP software includes a working space used to define program requirements, resources, schedules and budgets. The baseline plan and the EAC plan are typically updated within the working space and reported once a month (or more frequently depending upon a customer's requirements) to update the customer on the relative costs and progress of a project.

Disadvantageously, the working space of the SAP software allows for only one editable active plan to be open within the software at a time. The active plan represents the area on a computer screen where data, such as labor, materials or scheduling tasks, may be inputted. The data stored in the active plan is used to create the baseline plan and/or the EAC plan. Once created, the baseline plan and the EAC plan may not be edited or copied and re-pasted into the active plan. Therefore, intense and repeated manual data changes (such as to change resources, schedule and/or budget), which may include reentry of an entire plan into the working space, are required to revise either the baseline plan or the EAC plan. In addition, as only one editable plan may be open within the SAP software package at a time, the resource plans may not be simultaneously managed.

The data contained within the plans often must be continuously modified to reflect the updated costing and progress of the project and to generate costing reports necessary to communicate with a customer. In addition, the information stored within the plans must often be re-modified where a customer rejects a portion of either the baseline plan or the EAC plan. Often, depending upon the size of the project being managed, a modification based upon a customer's requirements may require thousands of manual modifications to be entered.

Finally, numerous errors in both the baseline plan and the EAC plan may result due to the confusion surrounding the status of the active plan. The potential for human error that results from the amount of manual modifications required to be made during the project management process significantly increases the time and labor necessary to manage a project.

Interface software is known which may be used in conjunction with the SAP software package to provide the ability to edit either the baseline plan or the EAC plan independently and simultaneously. However, interface software of this type is complex, expensive, and requires the user to perform dual maintenance tasks involved with maintaining both the SAP software as well as the interface software.

Accordingly, it is desirable to provide a method for automating the plan creation and maintenance of an enterprise resource planning system that is simple and operable within a single user interface.

### SUMMARY OF THE INVENTION

An example method for automating the management of an enterprise resource planning system comprises defining a first resource plan and storing the first resource plan into a first table, automatically storing the first resource plan into a resource plan space, and performing a first resource plan command and revising the first resource plan in response to a requested change. In one example, performing the first resource plan command includes retrieving the first resource plan from the first table and loading the first resource plan into a working space. A revised first resource plan is defined based upon the revisions made to the first resource plan. The revised first resource plan is stored within both the first table and the resource plan space.

A second resource plan is also defined and stored within a second table. In response to a requested change, a second resource plan command is performed and the second resource plan is retrieved from the second table and loaded into the working space. The second resource plan is revised within the working space to define a revised second resource plan. The revised second resource plan is subsequently stored within the second table.

In one example, a costing report is generated for each of the first resource plan and the second resource plan. In another example, revisions to the first resource plan are automatically reflected within the second resource plan.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a block diagram of an organizational management system

FIG. 2 illustrates an example user screen of the enterprise resource planning system of the present invention;

FIG. 3 is a block diagram illustrating an example method of automating the management of the enterprise resource planning system according to the present invention;

FIG. 4 is an example program management entry screen;

FIG. 5 is an example resource plan table for a first resource plan;

FIG. 6 is an example resource plan table for a second resource plan;

FIG. 7 is an example costing report;

FIG. 8 is a block diagram illustrating an example method for revising a defined resource plan in the enterprise resource planning system according to the present invention;

FIG. 9 illustrates an example function of a working space; and

FIG. 10 illustrates a second example function of the working space.

### DETAILED DESCRIPTION OF THE PREFERRED EMBODIMENT

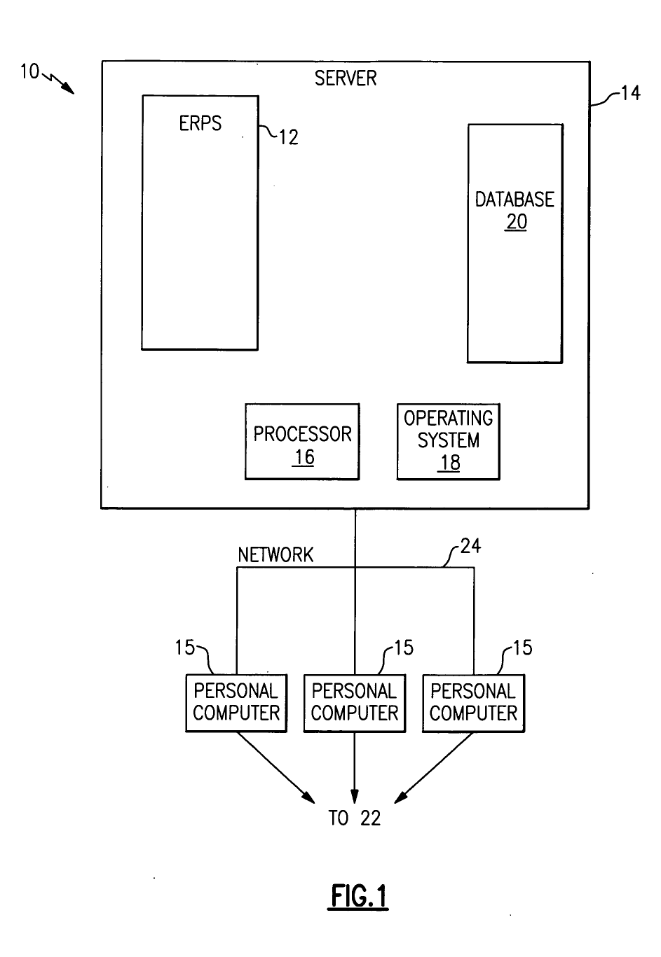

Referring to FIG. 1, an organizational management system 10 utilizing an enterprise resource planning system (ERPS) 12 is illustrated. The ERPS 12 is a software package that includes a plurality of business modules which provide functional support for the management of various aspects of a business organization including but not limited to sales, delivery, manufacturing and project management. One example ERPS 12 is commercially available from SAP AG of Germany under the trade name SAP (Systems, Applications and Products in Data Processing). Although the present invention is shown and described in terms of a SAP software package, it should be understood that any known ERPS 12 may be utilized in accordance with the present invention.

The organizational management system 10 includes a server 14, a processor 16, an operating system 18 and a database 20. The organizational management system 10 is remotely accessible by a plurality of users 22, such as deployed analysts and program analysts, through a network 24. In one example, the plurality of users 22 access the organizational management system 10 through personal computers 15. The ERPS 12 is executable by the server 14 in conjunction with the execution of the operating system 18 by the processor 16. The database 20 stores a plurality of information pertaining to a business which is accessed and utilized to manage the ERPS 12 by each of the plurality of users 22 as needed.

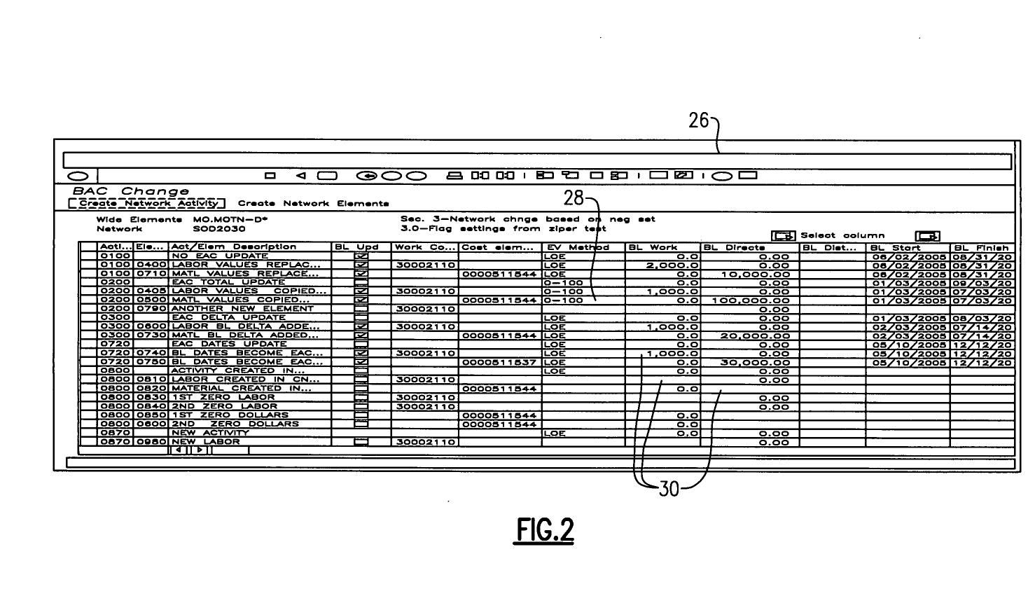

Referring to FIG. 2, an example user screen 26 of the ERPS 12 for managing an aspect of a business organization is illustrated. The illustrated example is disclosed in the context of a program management module of an SAP software package. However, any other known program module may utilize the various aspects of the present invention. The user screen 26 includes a working space 28 for creating a plurality of resource plans for modeling a particular program, such as an engine development program. The working space 28 represents the location where the active plan of the program being modeled is created, modified and stored. For example, a first resource plan and a second resource plan may be created and managed within the ERPS 12. In one example, the first resource plan is a baseline plan. The baseline plan is the original plan for a project which predicts the total amount of labor, materials and scheduling requirements needed to successfully implement the project. In another example, the second resource plan is an estimate at complete (EAC) plan. The EAC plan represents the operating plan for the project being modeled based upon revisions that occur to the baseline plan as time progresses during the project development process. It should be understood that the ERPS 12 according to the present invention may be optimized to create and manage any number and type of resource plans.

The working space 28 includes a plurality of editable fields 30 for entering program requirements. The program requirements consist of labor requirements, material requirements, scheduling requirements or any other data requirement. The baseline plan and the EAC plan are maintained simultaneously and independently within the ERPS 12, as is further discussed below.

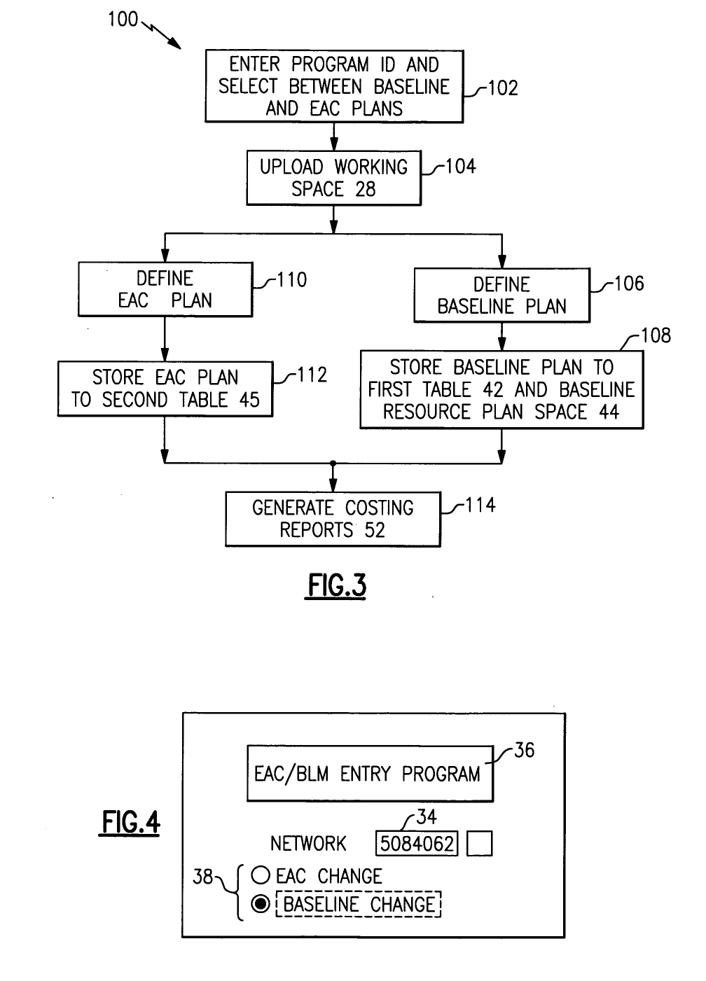

Referring to FIG. 3, and with continuing reference to FIGS. 1 and 2, a method 100 for automating the management of new project file of the ERPS 12 according to the present invention is illustrated. In the illustrated example, the method 100 is utilized to automate the management of a new engine development program. However, the method 100 of the present invention is not limited to program management.

The method 100 begins at step block 102 where a program ID number is entered into a query box 34 of a program management entry screen 36 (See FIG. 4). The ERPS 12 associates the program ID number with a stored project file which corresponds to the program the user wishes to create or manage (i.e. the engine development program). The user further selects between the baseline plan and the EAC plan. At the beginning of the development of a project file (i.e. time=0), the baseline plan and the EAC plan are identical. A radio button 38 (FIG. 4) may be toggled to select between the baseline plan and the EAC plan at the program management entry screen 36. At step block 104, the working space 28 of the project file selected in step 102 is uploaded.

The baseline plan is defined at step block 106 where the baseline plan is selected at step block 102. At the plan creation stage, the baseline plan is defined prior to the EAC plan. In one example, the baseline plan includes a plurality of program requirements. The program requirements include at least one of a labor requirement, a materials requirement, a scheduling requirement or any other program requirement. For example, the engine development program may require 100 hours of labor to implement the program. To recognize the labor requirement within the baseline plan, the 100 hours are entered in the editable field 30 of the working space 28 which corresponds to the labor requirements of the project file.

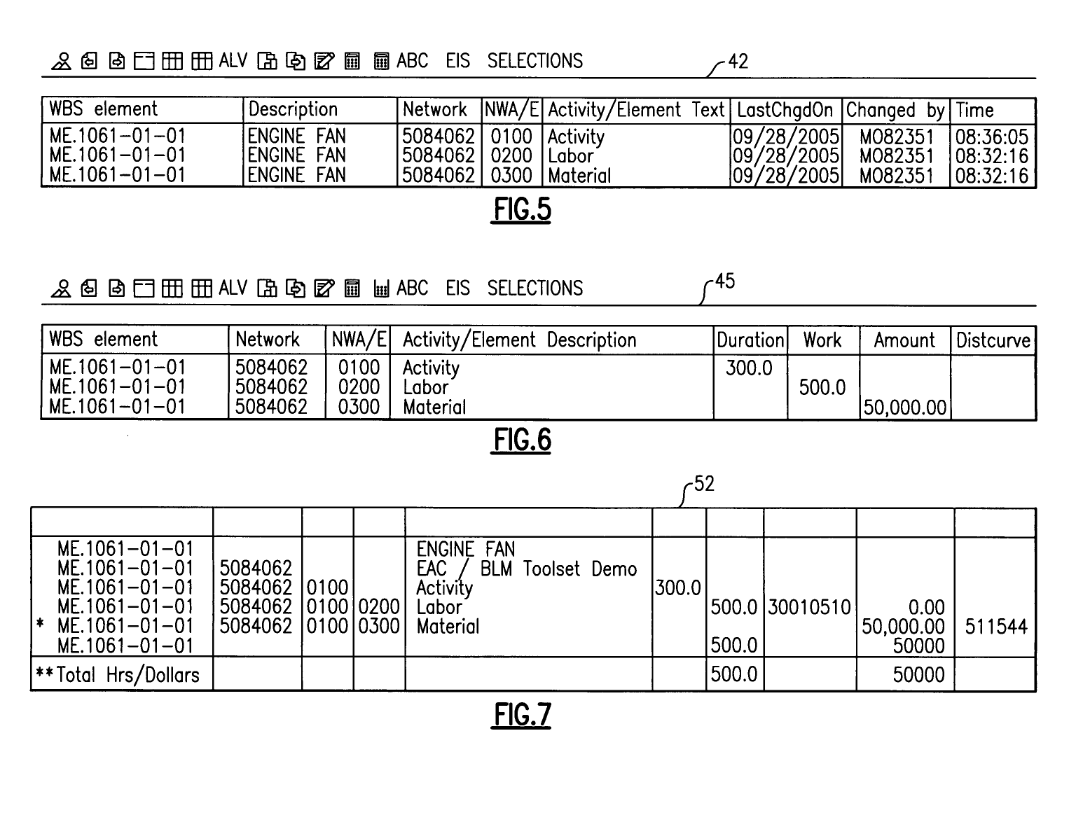

The baseline plan is automatically stored to a first table 42 (See FIG. 5) at step block 108 by manipulating a save button within the working space 28. The first table 42 is an updateable table such that the information stored within the first table 42 may subsequently be uploaded and edited within the working space 28. Simultaneously with step block 108, the baseline plan is copied and stored within a baseline resource plan space 44. The resource plan space 44 is not editable and functions to permanently store the baseline plan.

The EAC plan is defined at step block 110 where the project file selected at step block 102 is the EAC plan. The EAC plan includes a plurality of program requirements which include at least one of a labor requirement, a materials requirement, a scheduling requirement or any other program requirement. For example, subsequent to defining the baseline plan assume, e.g., it is realized that the 100 labor hours reflected in the baseline plan are inadequate to implement the project file. It is determined that a 200 hour increase in the number of labor hours is required. The increase to 300 labor hours is defined in the EAC plan at step block 110 by entering the new program requirement into the editable field 30 which corresponds to the labor requirements of the project file. Next, at step block 112, the EAC plan is copied to a second table 45 (See FIG. 6) by manipulating a save button within the working space. The second table 45 is updateable such that the information stored within the second table 45 may be uploaded and edited within the working space 28 as project requirements change.

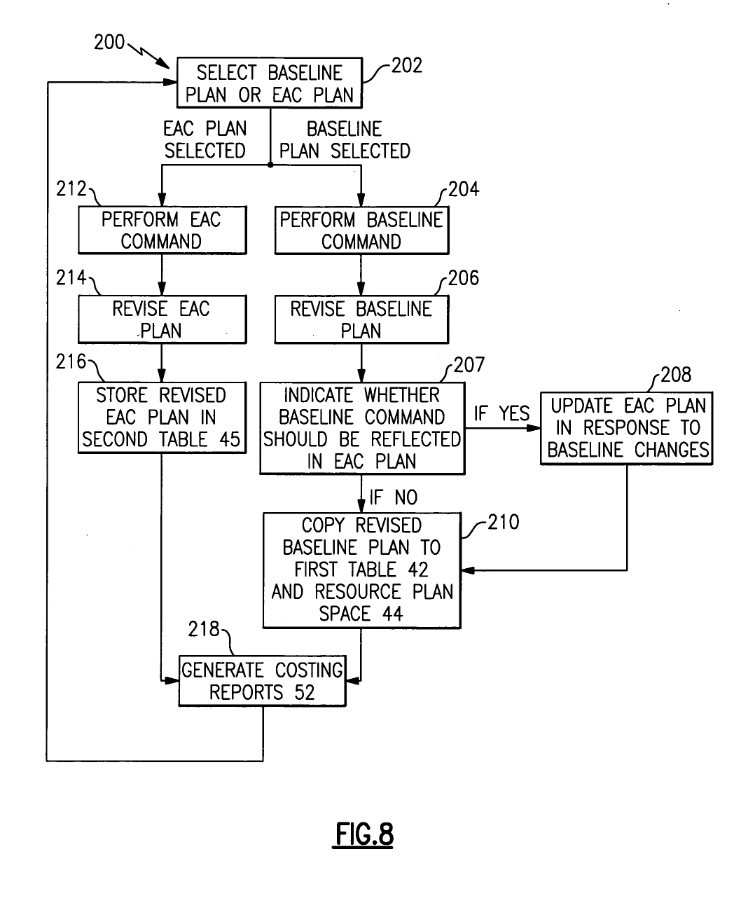

At step block 114, a costing report 52 (See FIG. 7) is generated for each of the baseline plan and the EAC plan. The costing report includes cost information relative to each of the resource plans of the project file, which includes an individual inventory of each program requirement defined in step block 106 and 110. Each program requirement is associated with a corresponding pre-defined costing rate programmed within the ERPS 12 in the form of a rate determination logic. The ERPS 12 is programmed to generate the costing report 52 in response to the program requirements and the rate determination logic. For example, assume again that the engine development program requires 100 hours of labor. This labor requirement is associated with a labor rate of $200 per hour. In addition, an overhead percentage of 300% is built into the rate determination logic. Therefore, the total cost of the labor requirements as defined in the baseline plan is $60,000. A person of ordinary skill in the art would be able to implement known rate determination logic for generating costing reports into the example method.

As stated above, the working space 28 is editable and the first table 42 and the second table 45 are updateable. That is, the information stored within these fields may be revised, copied, pasted or added to within the working space 28 and subsequently automatically saved within the first and second tables 42, 45. In addition, the working space 28, the first table 42 and the second table 45 are each accessible from the user screen 26 to provide a user friendly interface for the ERPS 12. Therefore, multiple resource plans may be managed simultaneously and independently within a single user interface of the ERPS 12.

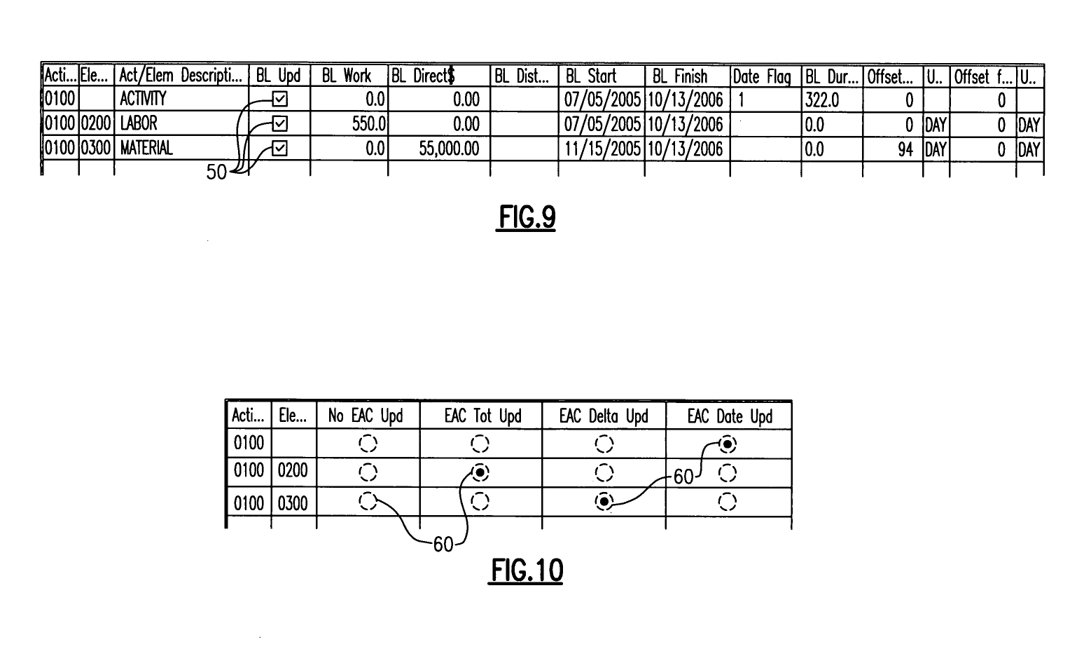

Referring to FIG. 8, and with continuing reference to FIGS. 1 through 7, an example method 200 for revising a defined resource plan within the ERPS 12 is illustrated. At step block 202, either the baseline plan or the EAC plan for a defined project file is selected at the program management entry screen 36. If the baseline plan is selected at the program management entry screen 36, a baseline command is automatically performed at step block 204. The baseline command is programmed into the ERPS 12 and instructs the system to retrieve the baseline plan from the first table 42 and load the baseline plan into the working space 28. At step block 206, the baseline plan is edited in response to a requested change, such as a customer initiated change, to create a revised first resource plan. In one example, a Baseline Update box 50 is checked to permanently store the requirements defined in step 106 within the baseline resource plan space 44 (See FIG. 9). Because the first table 42 is updateable, the required revisions to the baseline plan are reflected within the resource plan space 44 without the need to re-input the plurality of supporting data that the baseline plan is comprised of. That is, the required revision is reflected in the baseline plan while the remaining program requirements from the baseline plan which have not changed are retrieved from the first table 42 and uploaded into the working space 28.

In addition, at step block 207, it is indicated within the working space 28 whether the revisions made to the baseline should also be reflected within the EAC plan. In one example, the working space 28 includes a plurality of radio button 60 which identify the changes, if any, that a user wishes to reflect within the EAC plan (See FIG. 10). For example, the working space 28 may include a no update radio button, a total update radio button, a delta update radio button and a date update radio button.

The no update radio button is turned on where the revisions made to the baseline plan are not required to be reflected in the EAC plan. The total update radio button is turned on if a labor or material requirement revision made to the baseline plan is required to be reflected in the EAC plan. The delta update radio button is turned on where only the difference between the baseline plan labor or material requirement and the revised baseline plan labor or material requirement is desired to be reflected in the EAC plan. The date update radio button is turned on where a revision to a scheduling requirement of the baseline plan is required to be reflected within the EAC plan. If at least one radio button 60 (with the exception of the no update radio button) is turned on, the revised baseline plan is reflected within the EAC plan at step block 208. The revised baseline plan is then automatically copied and stored in the fist table 42 and the resource plan space 44 at step block 210.

If the EAC plan is selected at the program management entry screen 36, an EAC command is automatically performed at step block 212. The EAC command is programmed into the ERPS 12 and instructs the ERPS 12 to retrieve the EAC plan from the second table 45 and load the EAC plan into the working space 28. The EAC plan is next revised in response to a requested change to create a revised EAC plan at step block 214. Beneficially, because the second table 45 is updateable, the required revisions to the EAC plan are reflected in the revised EAC plan without the need to re-input the plurality of supporting data that the EAC plan is comprised of. That is, the required revision is manually reflected in the EAC plan while the remaining program requirements from the baseline plan which have not changed are retrieved from the first table 42 and loaded into the working space 28. At step block 216, the revised EAC plan is stored within the second table 45. Costing reports 52 of both the baseline plan and the EAC plan and regenerated at step block 218. Next, the method 200 returns to step block 202 where the method 200 may be repeated for each required change to either or both of the baseline plan and the EAC plan.

To illustrate the method 200, assume the labor requirement of 300 hours for the EAC plan as defined above with respect to step block 110 of the method 100 is communicated to a customer (in a costing report 52) for approval. However, the customer approves only a 100 hour increase in the labor requirement budget. Therefore, the EAC plan must be revised to reflect 200 hours in the labor requirement field rather than 300 hours as defined in step block 110. Utilizing the EAC command, the EAC plan is retrieved from the second table 45 and uploaded in the working space 28. The 200 hour labor requirement is then entered in the corresponding editable field 30 to replace the 300 hours previously entered to define the revised EAC plan. The revised EAC plan is next saved to the second table 45. The entire process is subsequently repeated for any other required changes later identified.

The examples contained in this description for illustrating the example methods of the present invention have been simplified in the interests of brevity. It should be understood that the amount of revisions necessary in managing a project file within the ERPS 12 may often included thousands of modifications. The enhancements provided by the present invention greatly alleviate the burdens associated with the management of the ERPS by automating the plan creation and revision process thereof.

The foregoing description shall be interpreted as illustrative and not in a limiting sense. A worker of ordinary skill in the art would recognize that certain modification would come within the scope of this invention. For that reason, the following claims should be studied to determine the true scope and content of this invention.

What is claimed is:

1. A method of automating the management of an enterprise resource planning system, comprising the steps of:
(a) defining a first resource plan and storing the first resource plan into a first table;
(b) automatically storing the first resource plan into a resource plan space;
(c) performing a first resource plan command and revising the first resource plan in response to a requested change.

2. The method as recited in claim 1, wherein said step (a) comprises:
defining the first resource plan in a working space.

3. The method as recited in claim 2, wherein the working space comprises at least one editable field.

4. The method as recited in claim 3, wherein at least one program requirement is defined within the at least one editable field.

5. The method as recited in claim 1, wherein said step (c) comprises:
retrieving the first resource plan from the first table.

6. The method as recited in claim 1, further comprising the step of:
(d) restoring the first resource plan in response to the revisions made in said step (c) to define a revised first resource plan.

7. The method as recited in claim 6, wherein said step (d) comprises:
storing the revised first resource plan into the first table and the resource plan space.

8. The method as recited in claim 6, further comprising the steps of:
(e) defining a second resource plan;
(f) automatically storing the second resource plan into a second table; and
(g) performing a second resource plan command and revising the second resource plan in response to a requested change to define a revised second resource plan.

9. The method as recited in claim 8, wherein said step (g) comprises:
retrieving the second resource plan from the second table; and
storing the revised second resource plan into the second table subsequent to the step of revising the second resource plan.

10. The method as recited in claim 8, further comprising the step of:
(h) repeating said steps (c) through (d) for each additional change required in the first resource plan and repeating said step (g) for each additional change required in the second resource plan.

11. The method as recited in claim 8, further comprising the step of:
(h) automatically modifying the second resource plan in response to revisions made to the first resource plan.

12. The method as recited in claim 8, further comprising the step of:
(h) creating a costing report of the revised first resource plan and a costing report for the revised second resource plan.

13. The method as recited in claim 8, wherein the second resource plan comprises an Estimate at Complete (EAC) plan.

14. The method as recited in claim 1, wherein the first resource plan comprises a baseline plan.

15. A method of editing a resource plan in an enterprise resource planning system, comprising the steps of:
(a) selecting at least one of a first resource plan and a second resource plan;
(b) retrieving the resource plan selected in said step (a) from one of a first table and a second table;
(c) revising the resource plan selected in said step (b);
(d) updating the resource plan revised in said step (c) to define a revised resource plan.

16. The method as recited in claim 15, wherein said step (b) comprises:
loading the resource plan selected in said step (a) into a working space.

17. The method as recited in claim 15, wherein said step (c) comprises:
storing the revised resource plan into the first table and a resource plan space where the resource plan revised in said step (c) is the first resource plan; and
storing the revised resource plan into the second table where the resource plan revised in said step (c) is the second resource plan.

18. The method as recited in claim 15, further comprising the step of:
(e) creating a costing report for the revised resource plan defined in said step (d).

19. The method as recited in claim 15, wherein said step (c) comprises:
modifying at least one program requirement.

20. An enterprise resource planning system user interface, comprising:
a working space for defining at least a first resource plan and a second resource plan;
a first table for storing said first resource plan; and
a second table for storing said second resource plan, wherein said first table and said second table are simultaneously and independently updateable within said working space.
